(19) United States
(12) Patent Application Publication
(10) Pub. No.: US 2006/0148918 A1
(43) Pub. Date: Jul. 6, 2006

(54) Process for the manufacture of a polymer foam

(75) Inventor: Pierre Dournel, Brussels (BR)

Correspondence Address: CONNOLLY BOVE LODGE & HUTZ, LLP, P O BOX 2207, WILMINGTON, DE, 19899, US

(73) Assignee: SOLVAY S.A., Brussele (BE)

(21) Appl. No.: 10/567,623

(22) PCT Filed: Aug. 6, 2004
(86) PCT No.: PCT/EP04/51734

§ 371 Date: Feb. 8, 2006

(30) Foreign Application Priority Data
Aug. 8, 2003 (EP) 03102488.8

(51) Int. Cl. C08G 18/48

(52) U.S. Cl. 521/131

(57) ABSTRACT

A process for manufacturing a polymer foam which comprises an exothermal foaming step carried out in the presence of a means for preventing heat accumulation.

The present invention relates to a process for the manufacture of a polymer foam, polymer foams and compositions which can be used in the manufacture of polymer foams.

Polymer foams are useful for example as thermal insulation material e.g. in buildings or constructions.

In the manufacture of polymer foams, especially block foams, notably by reaction of monomers in the presence of a blowing agent, a low quality of the foam is frequently caused by superheating of parts of the mixture during the foaming process.

It was desirable to find a foaming process which allows to obtain a high quality polymer foam.

Consequently, the invention concerns a process for manufacturing a polymer foam which comprises an exothermal foaming step carried out in the presence of a means for preventing heat accumulation.

An exothermal foaming step is understood to denote for example a heat-developing polymer-forming reaction wherein monomers are reacted optionally in the presence of a polymerization catalyst, which reaction is carried out in the presence of a blowing agent under conditions sufficient to bring about foaming of the polymer.

In a first particular example of a process involving an exothermal foaming step, at least one isocyanate is reacted with at least one polyol in the presence of at least one catalyst to manufacture a polyurethane or a modified polyurethane foam. Generally, in such a process, at least part of the blowing agent and reaction heat is generated by the hydrolysis reaction of isocyanates with water which forms CO₂. The process according to the invention allows for efficient manufacture of polyurethane foams while using a higher amount of water, especially in the case of the manufacture of block foams.

If water is present when a polyurethane or a modified polyurethane foam is manufactured in the process according to the invention, it is generally present in an amount of at least 0.1% by weight relative to the total amount of material present in the foaming step. Preferably, this amount is at least 0.4% by weight. When a polyurethane or a modified polyurethane foam is manufactured in the process according to the invention, typically, water is present in an amount of at most 1.5% by weight relative to the total amount of material present in the foaming step. Preferably, this amount is at most 1.0% by weight.

In a second particular example of a process involving an exothermal foaming step, at least one diphenol is reacted with at least one aldehyde in the presence of at least one catalyst to manufacture a phenolic foam.

Generally the process according to the invention is carried out in the presence of physical blowing agent. That means that such blowing agent is not formed during the foaming step but externally supplied to the foaming step.

In the process according to the invention the means for preventing heat accumulation is generally effective at a temperature of at least 80° C. Preferably, this temperature is equal to or greater than about 90° C.

In the process according to the invention, the means for preventing heat accumulation may be supplied to the foaming step as a mixture with one of the materials present in said step. It may, for example, be supplied as a mixture with the optional physical blowing agent. Preferably, it may be supplied as a mixture with a monomer. If a (modified) polyurethane is manufactured, it may be preferably supplied as mixture with the polyol.

In a first embodiment, the means for preventing heat accumulation is a compound having an atmospheric boiling point of at least 80° C. Preferably, the compound has an atmospheric boiling point equal to or greater than 90° C. Generally, the compound has an atmospheric boiling point equal to or less than 150° C. Preferably, the compound has an atmospheric boiling point equal to or less than 120° C.

Generally the compound used in the first embodiment substantially does not react with other constituents of the foaming mixture under the foaming conditions.

Specific examples of compounds which can be used in the first embodiment of the process according to the invention are selected among perfluoroethers, in particular perfluoropolyethers, hydrofluoroethers in particular hydrofluoropolyethers, perfluorocarbons, hydrocarbons, in particular aliphatic hydrocarbons, ketones, ethers in particular ethers of glycols or glycerols, esters, and chlorinated hydrocarbons.

Perfluoropolyethers that can be used in the first embodiment of the process according to the invention are commercially available or can be obtained by known processes (see, for example, Améduri and Boutevin, Top. Curr. Chem. (1997), Vol. 192, p. 178-179). The perfluoropolyether can be obtained, for example, by a process comprising:
(a) the photooxidation of a fluoroolefin preferably chosen from hexafluoropropylene and tetrafluoroethylene;
(b) a chemical and/or physical treatment of the photooxidation product,
(c) a distillation in order to isolate the desired perfluoropolyether.

The chemical treatment may, for example, be a fluorination. The physical treatment may, for example, be a photolysis or a thermolysis. Perfluoropolyethers that can be used are, for example, those satisfying the general formulae CF₃— [(OCF(CF₃)—CF₂)ₐ—(O—CF₂)_{b}]O—CF₃ (I) and CF₃—[(OCF₂—CF₂)_{c}—(O—CF₂)_{d}]O—CF₃ (II) in which a, b, c and d independently denote integers greater than 0.

Particular examples of perfluoropolyethers are those marketed by SOLVAY SOLEXIS under the names GALDEN® and FOMBLIN®. Mention may be made, for example, of the perfluoropolyether FOMBLIN® PFS1 having a boiling point of about 90° C. at 101.3 kPa and an average molecular mass of about 460.

For the purposes of the present invention, the term “hydrofluoropolyethe” is understood to mean a compound essentially consisting of carbon, fluorine, oxygen and hydrogen atoms, containing at least one C—H linkage and comprising at least two, preferably three, C—O—C ether linkages, or a mixture of several compounds satisfying this definition. Often, the oxygen atoms in the hydrofluoropolyether are exclusively present within the C—O—C ether linkages. In general, the hydrofluoropolyether contains a plurality of C—H linkages. Specific examples of hydrofluoropolyethers contain at least one —CF₂H group. Hydrofluoropolyethers that can be used are, for example, those marketed by SOLVAY SOLEXIS under the name H-GALDEN®. Hydrofluoropolyethers that can be used may be obtained, for example, by a process like that described above for the manufacture of the perfluoropolyethers, preferably comprising a hydrogenation step. The boiling point of the hydrofluoropolyethers that can be used is greater than or equal to 80° C. at 101.3 kPa. An example of a suitable hydrofluoropolyether is hydrofluoropolyether H-GALDEN® Grade B, now called H-GALDEN® ZT85 having a boiling point at 101.3 kPa of about 88° C.

The hydrocarbons that can be used in the first embodiment of the process according to the invention may be linear, branched or cyclic and generally contain 7, 8, 9, 10, 11 or 12 carbon atoms. N-heptane or n-octane are very suitable. Among aromatic hydrocarbons, those containing at least one alkyl substituent on a benzene ring are preferred. Toluene, 1,2-xylene, 1,3-xylene, 1,4-xylene or mixtures thereof are most particularly preferred.

In another preferred embodiment, the hydrocarbon is a paraffinic hydrocarbon fraction which can be obtained by petrochemical refinery of hydrocarbon feedstocks. Such fractions are commercially available, for example from SHELL or EXXON, and are often characterised by their flash point. A paraffinic hydrocarbon fraction, which is suitable for use in the compositions according to the invention, has generally a flash point equal to or lower than 0° C., determined according to the standard IP 170 (Abel). Often, the flash point of the paraffinic hydrocarbon fraction is at most −10° C. A paraffinic hydrocarbon fraction selected from ISOPAR® C, ISOPAR® E, EXXSOL® DSP 80/110 and EXXSOL® DSP 100/120 is more particularly preferred.

In the first embodiment of the process according to the invention, the means for preventing heat accumulation is generally present in an amount of at least 0.5% by weight relative to the total amount of material present in the foaming step. Preferably, this amount is at least 2% by weight. In first embodiment of the process according to the invention, the means for preventing heat accumulation is generally present in an amount of at most 15% by weight relative to the total amount of material present in the foaming step. Preferably, this amount is at most 10% by weight.

If a physical blowing agent is present in the first embodiment of the process according to the invention, the means for preventing heat accumulation is generally present in an amount of about at least 5% by weight relative to the total weight of physical blowing agent, and means for preventing heat accumulation present in the foaming step. Preferably, this amount is at least about 20% by weight. If a physical blowing agent is present in the first embodiment of the process according to the invention, the means for preventing heat accumulation is generally present in an amount of at most about 60% by weight relative to the total weight of physical blowing agent and means for preventing heat accumulation present in the foaming step. Preferably, this amount is at most about 50% by weight.

Physical blowing agents and the compounds suitable for use in the first embodiment of the process according to the invention do not form azeotropes under the conditions of the foaming step and therefore the means for preventing heat accumulation can be used in a particularly effective way in the presence of physical blowing agent.

In a second embodiment, the means for preventing heat accumulation is a compound capable of endothermic decomposition at a temperature at least 80° C. Preferably, the compound has a decomposition temperature equal to or greater than 90° C. Generally, the compound has a decomposition temperature equal to or less than 120° C. Preferably, the compound has a decomposition temperature equal to or less than 110° C.

It should be understood that the decomposition temperature may be adjusted by using for example promoters or activators which reduce the said temperature.

Specific examples of compounds which can be used in the second embodiment of the process according to the invention are selected among carbamic acid derivatives which are preferably supplied externally to the foaming step and among chemical blowing agents for thermoplastic foams such as azodicarbonamide or carbonate salts. The latter compounds are frequently used in the presence of citric acid.

In the second embodiment of the process according to the invention, the means for preventing heat accumulation is generally present in an amount of at least 0.1% by weight relative to the total amount of material present in the foaming step. Preferably, this amount is at least 1% by weight. In the process according to the invention, the means for preventing heat accumulation is generally present in an amount of at most 10% by weight relative to the total amount of material present in the foaming step. Preferably, this amount is at most 5% by weight.

If a physical blowing agent is present in the second embodiment of the process according to the invention, the means for preventing heat accumulation is generally present in an amount of at least 1% by weight relative to the total weight of physical blowing agent and means for preventing heat accumulation present in the foaming step. Preferably, this amount is at least 10% by weight. If a physical blowing agent is present in the second embodiment of the process according to the invention, the means for preventing heat accumulation is generally present in an amount of at most 50% by weight relative to the total weight of physical blowing agent and means for preventing heat accumulation present in the foaming step. Preferably, this amount is at most 35% by weight.

The physical blowing agents, which are subject to degradation, are compatible with compounds capable of endothermic decomposition at a temperature at least 80° C.

If a physical blowing agent is present in the process according to the invention, it has generally an atmospheric boiling point equal to or greater than −30° C. Preferably, the atmospheric boiling point is equal to or greater than 0° C. If a physical blowing agent is present in the process according to the invention, it has generally an atmospheric boiling point equal of less than 80° C. Preferably, the atmospheric boiling point is equal to or less than 50° C.

Physical blowing agents which can be used in the process according to the invention are selected, for example, among hydrofluorocarbons and hydrocarbons. It is understood that both hydrofluorocarbons and hydrocarbons, as described hereafter can be used in the first and in the second embodiment of the process according to the invention as described here before.

For the purpose of the present invention, “hydrofluorocarbon” is understood to denote a molecule consisting of carbon, fluorine and hydrogen atoms. In particular, the hydrofluorocarbon may be selected from hydrofluoroalkanes.

Surprisingly, hydrofluorocarbon blowing agents are compatible with an effective use of means for preventing heat accumulation. High quality foams can be obtained, as to their density, cell structure, in particular their closed cell contents, and optional thermal insulation properties of the foam. A first preferred hydrofluorocarbon blowing agent comprises 1,1,1,3,3-pentafluorobutane (HFC-365mfc). Non-flammable mixtures comprising HEC-365mfc, for example with at least one further hydrofluorocarbon selected from 1,1,1,2-tetrafluoroethane, 1,1,1,2,3,3,3-heptafluoropropane and 1,1,1,3,3-pentafluoropropane, are particularly preferred.

More particularly, the following HFC-365mfc compositions can be used in the process according to the invention (weight %):

HFC-365mfc/HFC-227ea (80-95/5-20)

HFC-365mfc/HFC-134a (70-95/5-30)

HFC-365mfc/HFC-245fa (5-95/5-95), preferably (30-70/30-70), more preferably about 50/50.

These mixtures are particularly suitable for manufacturing block foams.

In another embodiment, HFC-365mfc compositions with hydrocarbons can be used in the process according to the invention. The following specific compositions may be used (weight %):

HFC-365mfc/n-pentane (1-99/1-99)

HFC-365mfc/isopentane (1-99/1-99)

HFC-365mfc/cyclopentane (1-99/1-99)

Among the latter, azeotropic compositions are preferred.

A second preferred hydrofluorocarbon blowing agent comprises 1,1,1,3,3-pentafluoropropane (HFC-245fa).

In specific embodiment, HFC-245fa compositions with hydrocarbons can be used in the process according to the invention. The following specific compositions may be used (weight %):

HFC-245fa/n-pentane (1-99/1-99)

HFC-245fa/isopentane (1-99/1-99)

HFC-245fa/cyclopentane (1-99/1-99)

Among the latter, azeotropic compositions are preferred.

A third preferred hydrofluorocarbon blowing agent comprises 1,1,1,2-tetrafluoroethane (HFC-134a).

For the purpose of the present invention, “hydrocarbon” is understood to denote a molecule consisting of carbon and hydrogen atoms. In particular, the hydrocarbon may be selected from alkanes.

Pentanes are preferred as hydrocarbon blowing agents.

n-Pentane, isopentane and cyclopentane are particularly suitable. n-Pentane or cyclopentane is particularly preferred. n-Pentane is more particularly preferred.

In a particular embodiment, a hydrocarbon blowing agent and a means for preventing heat accumulation comprising a hydrocarbon are introduced jointly into the process according to the invention. In this case, a fraction comprising at least two hydrocarbons, one having an atmospheric boiling point of at least 80° C. and the other a boiling point below 80° C. can be suitably introduced into the process. An example of such a fraction is a petrochemical fraction having a sufficiently broad boiling point range, in particular a fraction which has a progressive boiling characteristic. The petrochemical fractions described above are suitable.

In the process according to the invention, the foam has generally a thickness of at least 1 cm. Often, the thickness is at least 8 cm. Preferably, it has a thickness of at least 12 cm. In the process according to the invention, the foam has generally a thickness of at most 30 cm. Often, the thickness is at most 25 cm. Preferably, it has a thickness of at most 20 cm.

The foam bodies having the thickness described here before are often foam boards, for example for thermal insulation panels.

In the process according to the invention, the foam is preferably a block-foam. The foam block has generally a height of at least 30 cm. Often, the height is at least 50 cm. Preferably, it has a height of at least 80 cm. The foam block has generally a height of at most 200 cm. Often, the height is at most 150 cm. Preferably, it has a height of at most 100 cm.

The foam block has generally a volume of at least 0.5 m³. Often, the volume is at least 1 m³. Preferably, it has a volume of at least 2 m³. The foam block has generally a volume of at most 10 m³. Often, the volume is at most 8 m³ cm. Preferably, it has a volume of at most 6 m³.

The invention also concerns manufacture of block foams making use of the hydrofluorocarbon blowing agents as described herein before. In the process for manufacturing block foam according to the invention, often a foamable mixture is produced by mixing of the components e.g. in a mixing head. The foamable mixture can then be cast into an appropriate mould or onto a conveyor belt moving between walls of appropriate dimension.

The invention concerns also a polymer foam which is obtainable by the process according to the invention.

The polymer foams according to the invention can be used, for example, for insulation of refrigerated trucks, as insulation panels or as shaped parts for the insulation of tubes.

The invention concerns also a composition which comprises a physical blowing agent and a means for preventing heat accumulation as described above. The composition is, in particular, a foamable mixture for producing a polymer foam.

### EXAMPLE 1

### Manufacture of Block Foams Using Hydrofluorocarbon Blowing Agent

A premix containing 75 parts by weight of VORANOL® RN 490 polyether polyol, 25 parts by weight of STEPANPOL® 2352 polyester polyol, 12 parts by weight of trichloropropylphosphate, 1.5 of L-6900 surfactant, 0.5 parts by weight of dimethylcyclohexylamine, 0.8 parts by weight of water and 26 parts by weight of a (50/50 wt.) mixture of 1,1,1,3,3-pentafluoropropane and 1,1,1,3,3pentafluorobutane is prepared by mixing its components. 100 parts by weight of the premix is mixed with 91 parts by weight of DESMODUR® 44V20 polymeric MDI in a mixing head and is cast onto a conveyor belt having a breadth of 1.30 m, which moves horizontally between two vertical walls having a height of 1.50 m. A block foam having a density of about 35 kg/m³ is obtained which presents acceptable characteristics concerning surface structure, thermal conductivity and dimensional stability. No coloration of the foam due to superheating is observed.

### EXAMPLE 2

### Manufacture of Block Foams Using Hydrofluorocarbon Blowing Agent and Antiscorching Agent

A premix containing 75 parts by weight of VORANOL® RN 490 polyether polyol, 25 parts by weight of STEPANPOL® 2352 polyester polyol, 12 parts by weight of trichloropropylphosphate, 1.5 of L-6900 surfactant, 0.5 parts by weight of dimethylcyclohexylamine, 1.6 parts by weight of water, 4 parts by weight of H-GALDEN® ZT85 hydrofluoropolyether and 21.4 parts by weight of a (50/50 wt.) mixture of 1,1,1,3,3-pentafluoropropane and 1,1,1,3,3-pentafluorobutane is prepared by mixing its components. 100 parts by weight of the premix is mixed with 101 parts by weight of DESMODUR® 44V20 polymeric MDI and processed as in example 1. A block foam having a density of about 35 kg/m³ is obtained which presents acceptable characteristics concerning surface structure, thermal conductivity and dimensional stability. No coloration of the foam due to superheating is observed

1. A process for manufacturing a polymer foam which comprises an exothermal foaming step carried out in the presence of a means for preventing heat accumulation.

2. The process according to claim 1, wherein the means for preventing heat accumulation is a compound having an atmospheric boiling point of at least 80° C.

3. The process according to claim 2, wherein the means for preventing heat accumulation is present in an amount of 0.5 to 10% by weight relative to the total amount of material present in the foaming step.

4. The process according to claim 1, wherein the means for preventing heat accumulation is a compound capable of endothermic decomposition at a temperature of at least 80° C.

5. The process according to claim 4, wherein the means for preventing heat accumulation is present in an amount of 0.1 to 5% by weight relative to the total amount of material present in the foaming step.

6. The process according to claim 1, which is carried out in the presence of a physical blowing agent.

7. The process according to claim 6, wherein the physical blowing agent comprises a hydrofluorocarbon.

8. The process according to claim 7, wherein the hydrofluorocarbon blowing agent comprises 1,1,1,3,3-pentafluorobutane (HFC-365mfc) and/or 1,1,1,3,3-pentafluoropropane (HFC-245fa).

9. The process according to claim 6, wherein the physical blowing agent comprises a hydrocarbon.

10. The process according to claim 9, wherein the hydrocarbon blowing agent comprises n-pentane, isopentane or cyclopentane.

11. The process according to claim 6, wherein the physical blowing agent has an atmospheric boiling point of from −30° C. to less than 80° C.

12. The process according to claim 1, in which, in the foaming step, at least one isocyanate is reacted with at least one polyol in the presence of at least one catalyst to manufacture a polyurethane or a modified polyurethane foam.

13. The process according to claim 1, in which, in the foaming step, at least one diphenol is reacted with at least one aldehyde in the presence of at least one catalyst to manufacture a phenolic foam.

14. The process according to claim 1, wherein the foam has a thickness of at least 1 cm.

15. The process according to claim 1, wherein the foam is a block-foam.

16. A polymer foam which is obtainable by the process according to claim 1.

17. A composition which comprises a physical blowing agent and a means for preventing heat accumulation.

18. The composition according to claim 17, which is a foamable mixture for producing a polymer foam.

19. (canceled)

20. The process according to claim 6, wherein the physical blowing agent has an atmospheric boiling point of from 0° C. to 50° C.

21. A method for manufacturing a block foam which comprises a hydrofluorocarbon blowing agent in accordance with claim 7.
